(19) United States
(12) Patent Application Publication
(10) Pub. No.: US 2013/0231061 A1
(43) Pub. Date: Sep. 5, 2013

(54) Technique to provide an Absence Timer for Secure Port Access Control to Handle Base Station Remote Radio Power Outage

(71) Applicant: Robert GRIFFIOEN, Ottawa (CA)

(72) Inventor: Robert GRIFFIOEN, Ottawa (CA)

(21) Appl. No.: 13/674,309

(22) Filed: Nov. 12, 2012

Related U.S. Application Data
(60) Provisional application No. 61/606,128, filed on Mar. 2, 2012.

(51) Int. Cl. H04W 24/00

(52) U.S. Cl. CPC H04W 24/00
USPC 455/67.11

(57) ABSTRACT

There is provided a method of controlling a CPRI monitor port of a remote radio equipment following a powering cycle. Access to the CPRI monitor port is first detected. An absence timer decrementing process is started when the CPRI monitor port becomes inactive. The timer value is then stored in a region of persistent memory and the memory is updated as the absence timer is decremented. If a power cycle at the remote radio equipment is detected and the remote radio equipment powered on, the absence timer value is read from the persistent memory and the absence timer is re-started if the timer value is greater than zero.

### FIELD OF THE INVENTION

The present application relates generally to software timers in radio systems and more particularly to the provision of non-interrupted control of software timers in radio systems which do not have internal battery backup.

### BACKGROUND OF THE INVENTION

In wireless communication networks Remote Radio Equipment (RRE) can be located up to twenty kilometers from the radio equipment controller (REC) base station. The radio is connected to the base station using an optical fiber and the CPRI protocol for the Physical and Data Link communication layers. To assist in debugging and monitoring the CPRI control layer traffic the RRE is provided with a CPRI monitor port which can be configured to output the Data Link Layer HDLC frames over a serial port.

Access to this CPRI monitor port is controlled using a RRE Maintenance Terminal (RRE-MT) tool. This tool permits the field maintenance crew to enable or disable the output from the CPRI monitor port.

The CPRI monitor port is an EIA RS-422 interface for wireless operator maintenance personal to collect uplink and downlink HDLC data from the CPRI link connected to the REC.

The CPRI monitor port uses an internal hardware controlled HDLC gate to access the HDLC bit stream. When the uplink CPRI monitor is enabled, hardware copies the receive HDLC bit stream from the CPRI fiber to the CPRI monitor port. When the downlink CPRI monitor is enabled, the hardware multiplexes LAPB traffic from the radio software into the streaming LAPB traffic from the CPRI monitor port.

The output of the CPRI monitor port could pose a security risk to Radio Equipment manufacturer's company intellectual property. The CPRI Data Link layer could transport radio firmware loads and sensitive radio debug and control information. These are transported inside the downlink and uplink CPRI HDLC frames. The CPRI monitor port control software uses a CPU absence timer to ensure that the monitor port is not unintentionally left open.

When the RRE-MT tool is used to enable the CPRI monitor port HDLC gate, the operator has to configure an absence time out period (typically 1 hour, 1 day, 2 days, 3 days, 4 days or 5 days).

When the RRE-MT tool is disconnected the absence timer is started automatically. After the absence timer expires then the HDLC gate is disabled and there is no HDLC output over the CPRI monitor port.

The RRE has no internal battery backup so the CPRI monitor port absence timer can only run when the radio is powered up. The RRE can lose power following a software upgrade or regular maintenance.

After the RRE is powered backup the last absence timer value is lost; and the radio software does not have sufficient data to restart the absence timer. So the radio software has to initialize the CPRI monitor port HDLC gate to the safe or disabled state to prevent port unauthorized access.

If the wireless operator needs the CPRI monitor port output, then field staff has to be sent out again to the RRE site. If the monitor port is disabled early as a result of a power failure, the field staff has to communicate with the wireless operator to have them issue a command to the RRE to re-enable port access. This of course is expensive and time consuming.

### SUMMARY OF THE INVENTION

The present invention is directed to alleviating the problems of the prior art. In particular, the present invention is directed to a method of re-initiating the CPRI monitor port absence timer following an RRE power cycle.

According to an exemplary embodiment of the invention, there is provided a method of controlling a CPRI monitor port at a remote radio equipment following a powering cycle. Access to the CPRI monitor port is first detected. An absence timer decrementing process is started when the CPRI monitor port becomes inactive. The timer value is then stored in a region of persistent memory and the memory is updated as the absence timer is decremented. If a power cycle at the remote radio equipment is detected, the absence timer value is read from this persistent memory and the absence timer is re-started if the timer value is greater than zero.

In another exemplary embodiment of the invention, a system for controlling a CPRI monitor port at a remote radio equipment following a powering cycle is provided. A processor detects access to the CPRI monitor port. A clock operates as an absence timer for providing a countdown process when the CPRI monitor port becomes inactive. A memory then stores a timing value from the absence timer. The memory is updated during the countdown process, wherein if a power cycle at the remote radio equipment is detected, the processor retrieves the absence timer value from memory and triggers a re-start of the absence timer countdown process if the timer value is greater than zero.

### BRIEF DESCRIPTION OF THE DRAWINGS

FIG. 1 is a simple diagram to illustrate a typical remote radio equipment environment.

FIG. 2 is a block diagram of a RRE HDLC Gate used to enable and disable access to the CPRI monitor port;

FIG. 3 is a block diagram illustrating the RRE functional blocks for use with the present invention;

FIG. 4 is a flow diagram of the RRE-TM Absence Timer Update Handling; and

FIG. 5 is a flow diagram illustrating the Restoring Absence Timer after a Power Outage.

### DETAILED DESCRIPTION OF THE EMBODIMENTS

In order to lighten the following description, the following acronyms will be used:
CPRI Common Public Radio Interface
EEPROM Electronically Erasable and Programmable Read-Only Memory
HDLC High-Level Data Link Control
REC Radio Equipment Control
RE Radio Equipment
RRE-MT Remote Radio Equipment Maintenance Terminal
RRUS Remote Radio Unit Sub-System

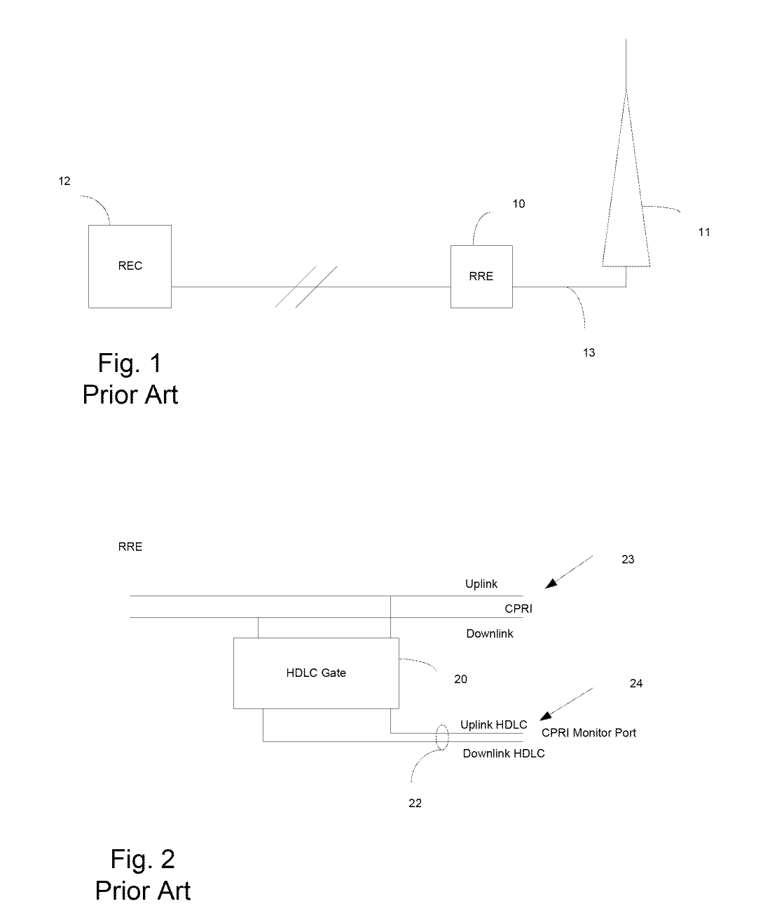

FIG. 1 illustrates a typical Remote Radio Equipment environment whereby the base station or RRE 10 which is connected to a radio tower 11 can be located several kilometers from the Radio Equipment Controller 12. The radio is connected to the base station using an optical fiber 13 operating with a CPRI protocol for the Physical and Data Link communication layers.

FIG. 2 shows an HDLC Gate 20 provided by the radio hardware to control Data Link Layer access 21 to the CPRI HDLC data over the CPRI monitor port 22. The HDLC Gate 20 is used to assist in debugging and monitoring the CPRI control layer traffic 23. This is accomplished by providing the CPRI monitor port 22 which is configured to output Data Link Layer HDLC frames 24 over a serial port 22. Field maintenance crews make use of an RRE Maintenance Terminal (RRE-MT) tool to access this port.

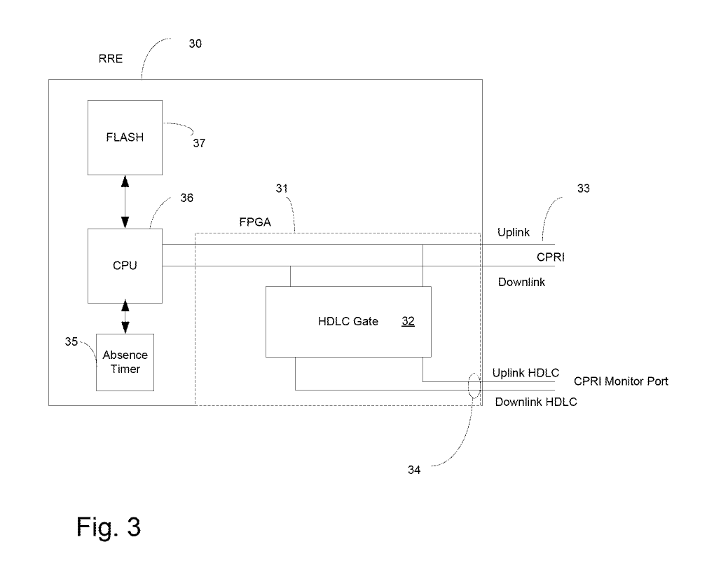

FIG. 3 is a block diagram illustrating the RRE functional blocks for use with the present invention. The RRE 30 is provided with an FPGA board 31 with an HDLC Gate 32 providing access to the CPRI uplink and downlink ports 33 and a CPRI monitor port 34.

An absence timer 35 determines the length of time CPRI monitor port 34 can remain accessible to a maintenance crew following an RRE power cycle. The radio CPU 36 controls the absence timer 35 and a FLASH memory 37 for storing the time the absence timer was started as well as periodic decremented timer values.

The decremented absence timer values are stored in a region of persistent memory such as a circular buffer to prevent FLASH degradation. Following the radio restart, CPU software can recover from FLASH sufficient data to re-compute the remaining absence timer interval. If there is remaining time, the CPU's RRE control software can restart the absence timer 35 at the stored time interval and disable access the CPRI monitor port HDLC gate once the absence timer counts down to zero.

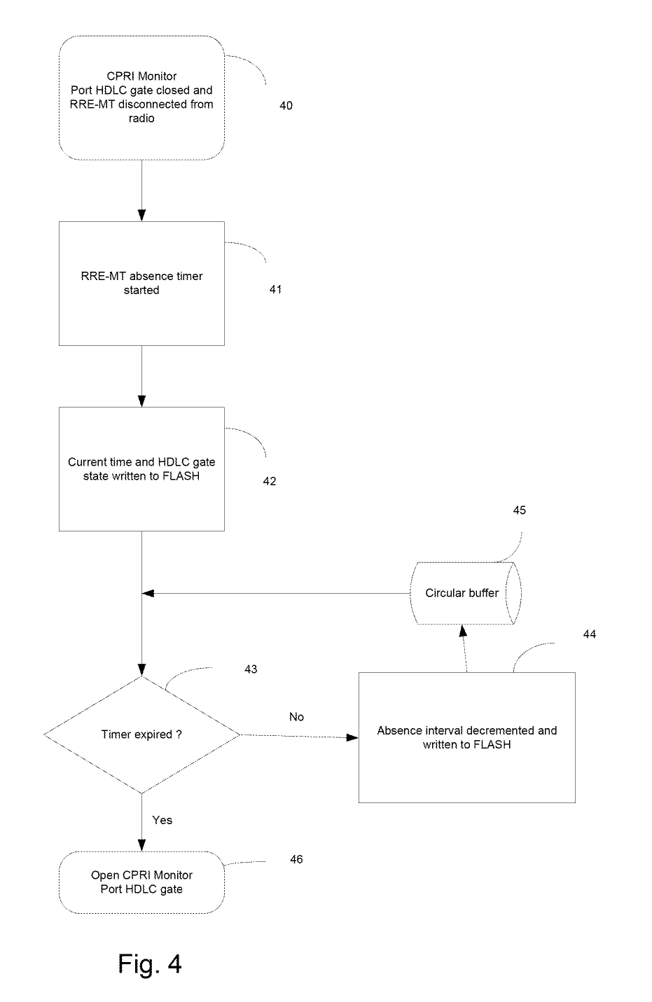

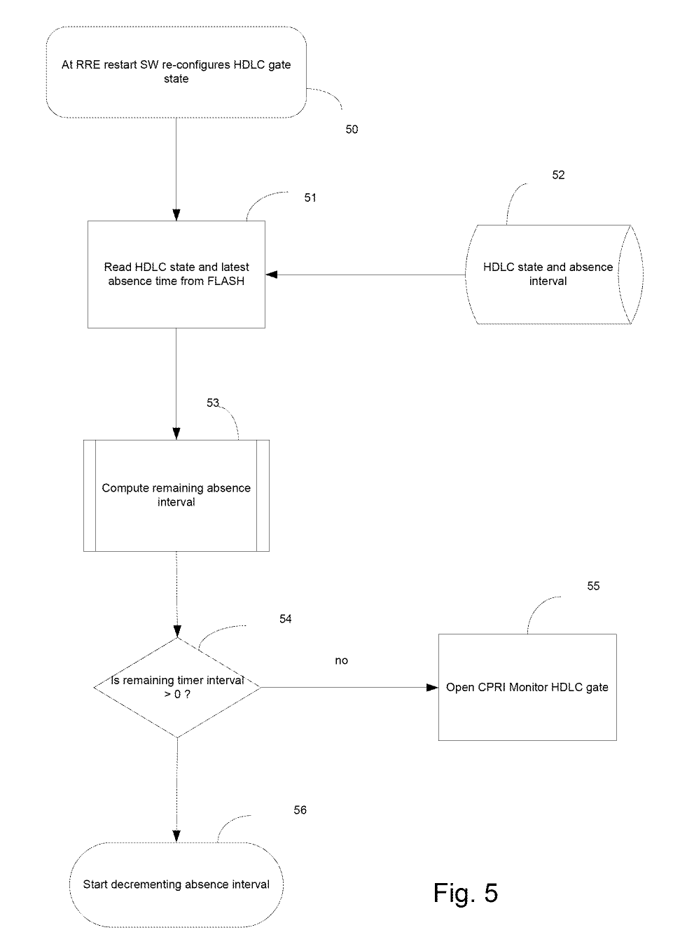

CPRI Monitor Port absence timer must be implemented such that it takes into account the time when a RRUS is powered down. The RRE does not have any internal battery to permit the CPU to log time during the power-off interval. The flow charts of FIGS. 4 and 5 show how the CPU control software maintains the remaining absence time interval and recovers it following a power outage.

In the following description, the HDLC gate has an open and closed state. An open state means that the HDLC gate circuit is ‘open’ ie. the monitor port is not accessible to read CPRI data. A closed state means that the HDLC gate circuit is ‘closed’, ie. the monitor port is accessible to read CPRI data.

As illustrated in FIG. 4, the absence timer update flow chart is triggered block 40 when the HDLC gate is in a closed state, thus providing access to the CPRI Monitor Port, and the maintenance crew disconnects the RRE-MT tool. At block 41, the CPU software begins decrementing the configured absence time. At block 42, both the time when timer is started and the decremented interval count are written to FLASH. To avoid excessive FLASH wear, the decremented interval is written to a circular buffer. At block 43, if the timer has not expired, the decremented interval continues to be written to FLASH at block 44 and a circular buffer block 45. This is done until the absence timer reaches zero at which point, the HDLC gate opens (block 46) and disconnects access to the CPRI Monitor Port.

With reference to FIG. 5, if a power failure has occurred, the FLASH memory maintains the last stored value of the absence timer 35. At a power down and restart of the RRE (block 50), the CPU control software must determine if there is any remaining time on the CPRI Monitor Port absence timer (block 51, 52 and 53). At block 54, if there is no remaining count then the HDLC gate is open and disables (block 55) access to the port, otherwise the absence timer continues to count down (block 56) and the port remains configured accessible to maintenance crews if required.

The algorithm used to determine whether to open HDLC gate or close it uses the following pseudo code:

remaining_absence_interval = [HDLC_gate_closed_start_time +
latest_absence_interval]-RRE_current_time
IF remaining_absence_interval > 0 THEN leave HDLC gate closed
ELSE open HDLC gate

EEPROM and FLASH memory media have individually erasable segments, each of which can be put through a limited number of erase cycles before becoming unreliable. This is usually around 3,000/5,000 cycles but this is extended to 100,000+ cycles using wear levelling. The RRE-MT CPRI Monitor Port remaining absence timer value is written to FLASH every minute. It is written to a circular buffer designed to not exceed the wear limit and to handle the maximum expected absence timer interval. Using a limit of 100,000 R/W cycles; a maximum absence timer interval of 5 days; and a 10 year life HW span then the following ring buffer size would be suitable:

Max_absence_interval=5*24*60=7200

Max_num_absence=10*365*24*60/(5*24*60)=730

Max_rw_cycles=100000

Buffer_size (words)=Max_absence_interval*2* Max_num_absence/(Max_rw_cycles)=˜106 bytes

The invention can be used to provide non-interrupted control of software timers in radio systems which do not have internal battery backup. It supports secure access control of external data monitoring ports following power outages due to:
Radio restart after software upgrade
Radio restart after scheduled maintenance
Radio restart to clear unrecoverable faults

I claim:

1. A method of controlling a CPRI monitor port at a remote radio equipment following a powering cycle, comprising the steps of:
a) detecting access to said CPRI monitor port;
b) starting an absence timer decremented process when said CPRI monitor port becomes inactive;
c) storing a timer value to a region of persistent memory;
d) updating said memory as said absence timer is decrementing in value;
e) if a power cycle at said remote radio equipment is detected, reading the absence timer value from said region of persistent memory; and
f) re-starting said absence timer decremented process if said timer value is greater than zero.

2. A method as defined in claim 1, wherein said persistent memory is a flash memory.

3. A method as defined in claim 2, further comprising the step of de-activating said CPRI monitor port if said absence timer is zero.

4. A method as defined in claim 3, wherein access to said CPRI monitor port is controlled via a data link layer gate.

5. A method as defined in claim 4, wherein said memory is updated at specified intervals.

6. A method as defined in claim 5, wherein said specified intervals are determined according to a predetermined number of read/write cycles of said memory.

7. A method as defined in claim 6, wherein said memory operates a circular buffer in FLASH according to said read/write cycles.

8. A system for controlling a CPRI monitor port at a remote radio equipment following a powering cycle, comprising:
a) a processor for detecting access to said CPRI monitor port;
b) a clock operating as an absence timer for providing a countdown process when said CPRI monitor port becomes inactive;
c) a memory unit having a region of persistent memory for storing a timing value from said absence timer, said memory unit being updated during the countdown process, wherein if a power cycle at said remote radio equipment is detected, said processor retrieves the absence timer value from said region of persistent memory and triggers a re-start of said absence timer countdown process if said timer value is greater than zero.

9. A system as defined in claim 8, wherein said region of persistent memory is provided by a flash memory.

10. A system as defined in claim 9, wherein said processor de-activates said CPRI monitor port if said absence timer is zero.

11. A system as defined in claim 10, wherein access to said CPRI monitor port is controlled via a data link layer gate.

12. A system as defined in claim 11, wherein said region of persistent memory is updated at specified intervals.

13. A system as defined in claim 12, wherein said specified intervals are determined according to a predetermined number of read/write cycles of said memory.

14. A system as defined in claim 13, wherein said memory operates a circular buffer in FLASH according to said read/write cycles.
